(19) United States
(12) Patent Application Publication
(10) Pub. No.: US 2007/0139561 A1
(43) Pub. Date: Jun. 21, 2007

(54) Reproducing apparatus

(75) Inventors: Shunichi Kawabata, Tokyo (JP); Ryohei Furumachi, Tokyo (JP); Takero Kobayashi, Tokyo (JP); Kazutoshi Horiguchi, Tokyo (JP); Hideyuki Tsutsumitake, Kanagawa (JP); Yasuhiro Ishibashi, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/478,625

(22) Filed: Jul. 3, 2006

(30) Foreign Application Priority Data
Dec. 16, 2005 (JP) 2005-363681

(51) Int. Cl. H04N 9/74

(52) U.S. Cl. 348/584; 386/40

(57) ABSTRACT

The invention provides a reproducing apparatus with which a user can confirm a selection situation about video output terminals before or in connection between an external video-displaying portion and the reproducing apparatus, and can suitably perform the connection between them. Before a reproducing apparatus (1) is connected to a TV apparatus (30) or (31), to which of video terminals a terminal through which a video signal is to be outputted corresponds is visually displayed on a displaying portion (100) provided in a front panel (10) of the front of a main body, whereby even in case of the reproducing apparatus including a plurality of video output terminals, a user can readily and reliably connect a video cable. Also, since not only information on a kind of video terminal, but also information on resolution of the video signal are displayed on a video output-displaying portion (126), it is also possible to dissolve such nonconformity that no image is displayed on a screen in spite of obtaining a connection state.

The present application is based on Japanese patent application No. 2005-363681, the entire contents of which are incorporated herein by reference.

### BACKGROUND OF THE INVENTION

1. Field of the Invention

The present invention relates to a reproducing apparatus for reading out image information from a disc-like storing medium such as a digital versatile disc (DVD) and instructing an external video-displaying portion as a separate apparatus to display an image corresponding to the image information thus read, and more particularly to a reproducing apparatus with which a user can confirm a selection situation about video output terminals before or in connection between an external video-displaying portion and the reproducing apparatus, and also can suitably connect the reproducing apparatus to the external video-displaying portion.

2. Description of Related Art

In recent years, in video apparatuses typified by a television (TV) apparatus, an apparatus coping with digital broadcasting in addition to existing analog broadcasting has been becoming popular. In addition, for a moving picture such as a video image which can be displayed on the TV apparatus, there is being carried on the development of a reproducing apparatus which can treat an image from a DVD or a moving picture conforming to the high definition (HD) standard in accordance with which a larger-capacity and highly fine image can be provided.

In addition, the improvements in the TV apparatus have also been made in order to cope with the high fineness promotion and the diversification on the side of the reproducing apparatus side described above. Thus, the promotion for coping with the digital broadcasting in addition to the existing analog broadcasting has progressed. In the present circumstances, however, it is not easy for a user to precisely perform connection between these apparatuses. As a result, an image may not be suitably displayed, or an image may not be displayed at all.

With regard to a technique for solving such a problem, a DVD-reproducing apparatus is proposed which receives as its input aspect ratio information outputted from a video-displaying apparatus, and controls its video signal-outputting portion so that the video signal-outputting portion outputs a video signal corresponding to the aspect ratio information thus received, thereby saving the labor required for a user to manually set an aspect ratio. This DVD-reproducing apparatus, for example, is disclosed in the Japanese Patent Kokai No. 11-196436 A.

However, with the DVD-reproducing apparatus disclosed in the Japanese Patent Kokai No. 11-196436 A, when the connection between the DVD-reproducing apparatus and the video-displaying apparatus is not precisely performed, it is impossible to transmit and receive data. The AV apparatus of today includes a plurality of terminals in order to allow such an AV apparatus to be connected to a great variety of apparatuses. However, even when the connection is precisely performed in an installation stage, no signal may be outputted to the connected terminal. In such a case, there is encountered such a problem that a user is required to perform such a complicated manipulation as to manually change the misconnected terminal to proper one.

### SUMMARY OF THE INVENTION

In the light of the foregoing, it is an object of the present invention to provide a reproducing apparatus with which a user can confirm a selection situation about video output terminals before or in connection between an external video-displaying portion and the reproducing apparatus, and also can suitably perform the connection between them.

In order to attain the above-mentioned object, according to one aspect of the present invention, there is provided a reproducing apparatus, including: a remote controller having a terminal-switching portion for selecting a video terminal among a plurality of video terminals including terminals for a digital video output and an analog video output and serving to transmit a terminal-switching signal generated in accordance with a manipulation for the terminal-switching portion; and a main body for selecting the video terminal among the plurality of video terminals to be connected to an external video-displaying portion through respective cables by receiving the terminal-switching signal transmitted thereto, and having a displaying portion provided in a front panel, the displaying portion being used to display thereon information on a kind of the video terminal selected and information on resolution of a video signal to be outputted to the external video-displaying portion in a displaying form of characters.

In addition, in order to attain the above-mentioned object, according to another aspect of the present invention, there is provided a reproducing apparatus, including: a remote controller having a terminal-switching portion for selecting a video terminal among a plurality of video terminals including a terminal for a digital video output or an analog video output obtained from a disc-like storing medium through reproduction and serving to transmit a terminal-switching signal generated in accordance with a manipulation for the terminal-switching portion; and a main body, the main body, including: a video-switching portion for selecting the video terminal among the plurality of video terminals to be connected to an external video-displaying portion through respective cables by receiving the terminal-switching signal transmitted thereto; a decoding portion for forming a video signal corresponding to an output system of the video terminal selected; and a displaying portion provided in a front panel for displaying thereon information on a kind of the selected video terminal and information on resolution of the video signal to be outputted to the external video-displaying portion in a displaying form of characters.

According to the present invention, a user can confirm the selection situation about the video output terminals before or in connection between the external video-displaying portion and the reproducing apparatus, and can suitably perform the connection between them.

### BRIEF DESCRIPTION OF THE DRAWINGS

FIG. 1 is a block diagram showing a schematic configuration of a reproducing apparatus according to a first embodiment of the present invention;

FIG. 2 is a front view of a main body of the reproducing apparatus according to the first embodiment of the present invention;

FIG. 3 is a front view showing a state in which a front door provided in a front panel is opened;

FIG. 4 is a partially enlarged view of a displaying portion provided in the front panel;

FIG. 5 is a rear view of the main body of the reproducing apparatus according to the first embodiment of the present invention;

FIG. 6 is a view showing an overall remote controller for remotely controlling the reproducing apparatus according to the first embodiment of the present invention;

FIG. 7A to 7D are respectively schematic views showing connection forms between a TV apparatus as an external video-displaying portion and the reproducing apparatus according to the first embodiment of the present invention;

FIGS. 8A to 8C are respectively explanatory views each showing a displaying portion of the reproducing apparatus according to the first embodiment of the present invention in a stage in which the reproducing apparatus is unconnected to the TV apparatus;

FIG. 9 is a flow chart showing a flow of an initialization manipulation in the reproducing apparatus according to the first embodiment of the present invention;

FIGS. 10A to 10C are respectively explanatory diagrams each showing another method of displaying an image on an analog video output or a digital video output; and

FIG. 11 is a schematic structural diagram showing partially a reproducing apparatus according to a second embodiment of the present invention.

### DETAILED DESCRIPTION OF PREFERRED EMBODIMENTS

### First Embodiment

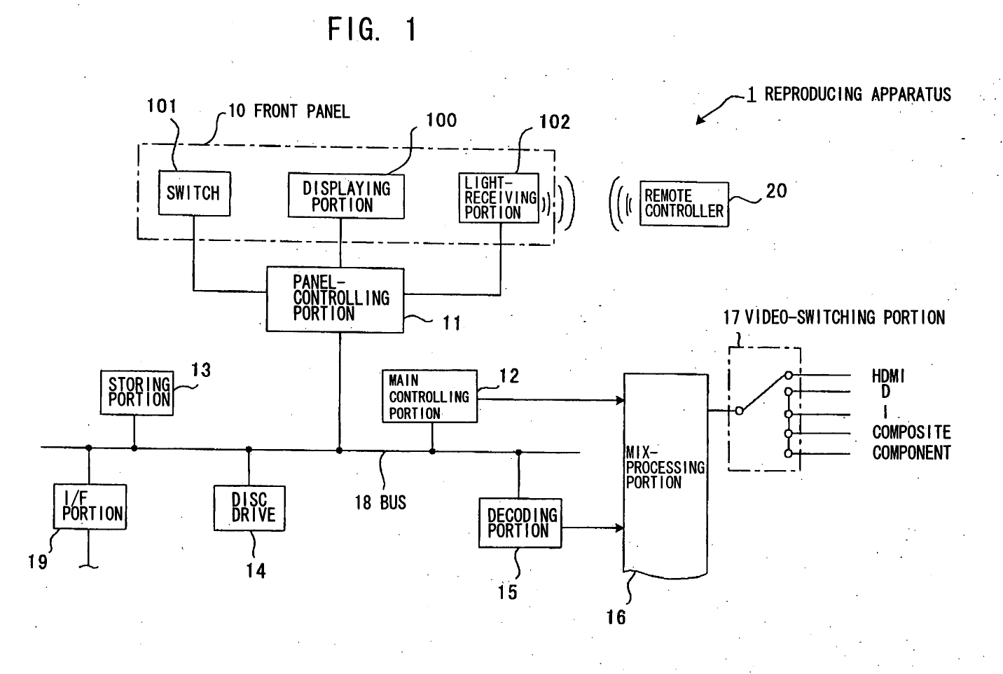

FIG. 1 is a block diagram showing a schematic configuration of a reproducing apparatus according to a first embodiment of the present invention.

### Configuration of Reproducing Apparatus 1

A reproducing apparatus 1 is a DVD-reproducing apparatus which can reproduce an image and a sound from a DVD disc conforming to the HD standard. The reproducing apparatus 1 includes a main body having a front panel 10 including a displaying portion 100 for showing display provided in accordance with a disc reproducing operation and an operating state of the reproducing apparatus 1, a switch 101 including switches with which a power source, a front door, a disc tray, and the like are manipulated, respectively, and a light-receiving portion 102 for performing optical communication with a remote controller 20 which will be described later, a panel-controlling portion 11 for controlling operations of the displaying portion 100, the switch 101, and the light-receiving portion 102 of the front panel 20, respectively, a main controlling portion 12 for controlling portions of the reproducing apparatus 1, a storing portion 13 for storing therein data such as firmware and a program required for the operation of the reproducing apparatus 1, a DISC drive 14 for driving a disc such as an HD DVD, a DVD or a CD, a decoding portion 15 including a video decoder for decoding data on an image reproduced by the DISC drive 14 to generate a video signal and an audio decoder for decoding a signal of a sound to generate an audio signal, a MIX-processing portion 16 for mixing the video signal and the audio signal outputted from the decoding portion 15 with each other to output a resulting signal, a video-switching portion 17 for selecting a video terminal among a plurality of video terminals provided in the reproducing apparatus 1, a bus 18, and an I/F portion 19 through which the reproducing apparatus 1 is connected to a network. Moreover, the reproducing apparatus 20 has a remote controller 20 for performing optical communication with the light-receiving portion 102 provided in the front panel 10 of the main body. At that, only a video output side of the MIX processing portion 16 is shown in the figure, and an audio output side thereof is omitted in illustration.

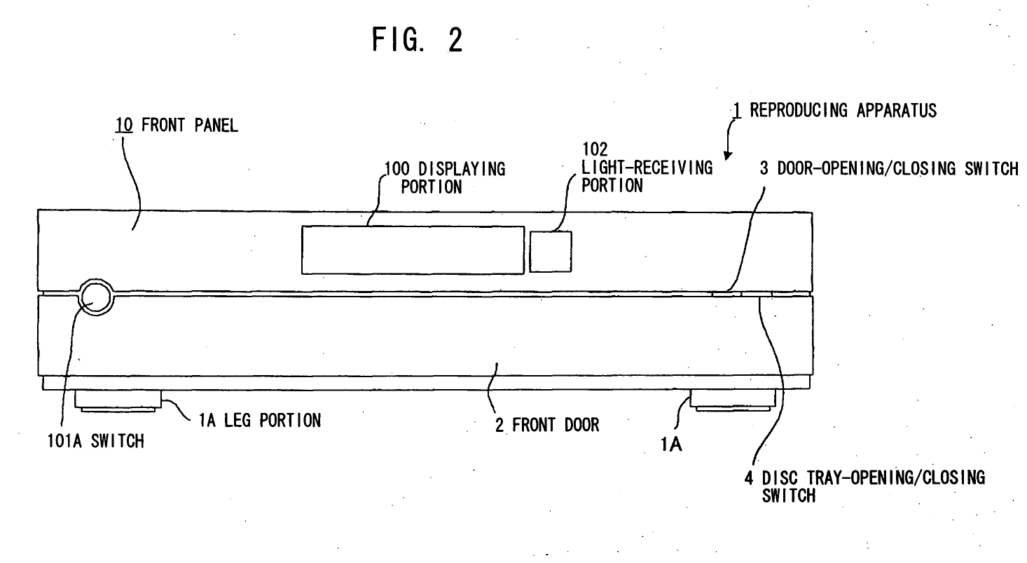

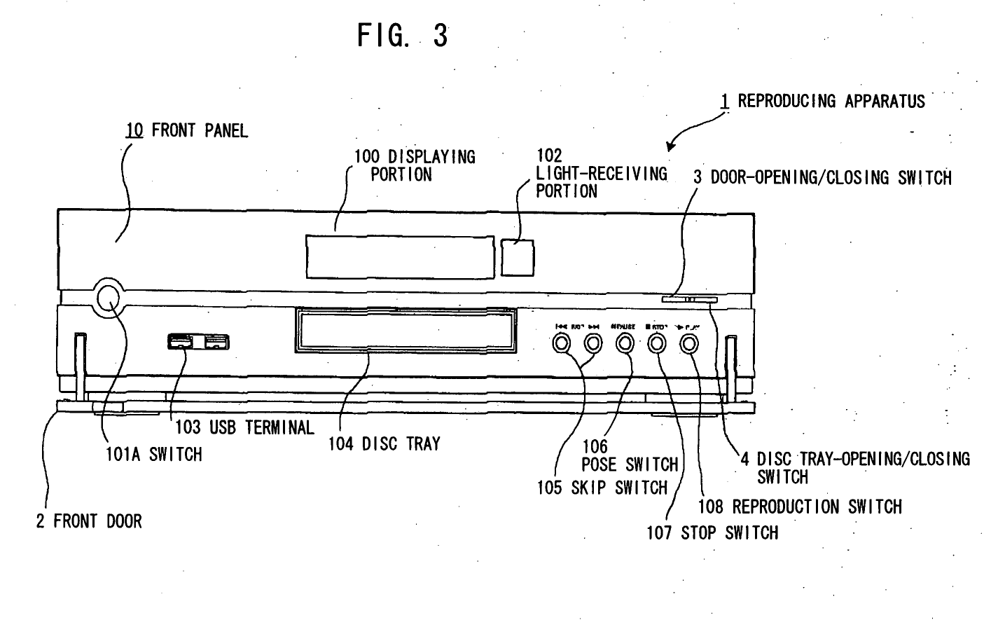

FIG. 2 is a front view of the main body of the reproducing apparatus 1 according to the first embodiment of the present invention, and FIG. 3 is a front view showing a state in which a front door 2 provided in the front panel 10 is opened. The reproducing apparatus 1 has the displaying portion 100 at a center of the front panel 10 provided in the front, and the front door 2 which is provided on a lower side of the displaying portion 100 and which can be opened/closed by a door-opening/closing switch 3. The front door 2 is opened in accordance with the manipulation for the door-opening/closing switch 3, thereby making a USB terminal 103 as an external connection terminal, a disc tray 104, and manipulation switches such as a skip switch 105, a pose switch 106, a stop switch 107, and a reproduction switch 108 which are manipulated in reproduction for the DVD appear as shown in FIG. 3. The USB terminal 103, the disc tray 104, and the switches 105, 106, 107 and 108 are provided in the rear of the front door 2. The reproducing apparatus 1 is supported by leg portions 1A. The disc tray 104 is opened/closed by manipulating a disc tray-opening/closing switch 4 provided on the right-hand side with respect to the center of the front. In addition, a switch 101A with which the power source is turned ON is provided on the left-hand side with respect to the center of the front panel 10.

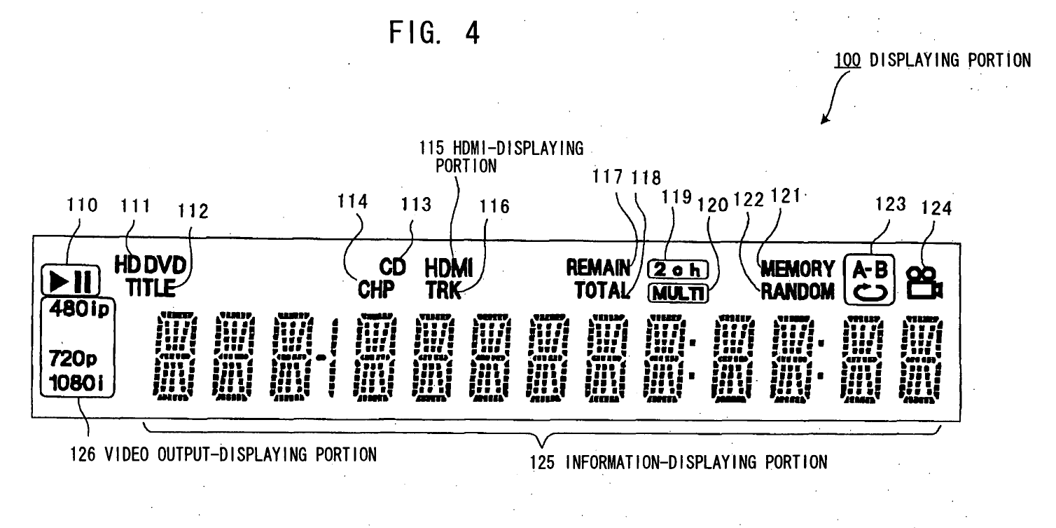

FIG. 4 is a partially enlarged view of the displaying portion 100 provided in the front panel 10. The displaying portion 100 serves to display thereon various pieces of information obtained in accordance with the reproduction for the DVD disc. The displaying portion 100 includes a reproduction state-displaying portion 110 for displaying information on the reproduction being performed and the reproduction being temporarily stopped, a disc-displaying portion 111 for displaying information on a kind of disc (DVD or HD DVD), a title-displaying portion 112 which is in an ON state while a title number is displayed, a CD-displaying portion 113 which is in an ON state while a CD is put on the disc tray 104, a chapter-displaying portion 114 which is in an ON state while a chapter number is displayed, an HDMI-displaying portion 115 which is in an ON state while a high-definition multimedia interface (HDMI) output is set, a track-displaying portion 116 which is in an ON state while a track number is displayed, a remaining time-displaying portion 117 which is in an ON state while information on a remaining time is displayed, and a total time-displaying portion 118 which is in an ON state while information on a total time recorded in the disc is displayed. In addition, the displaying portion 100 includes a 2 ch-displaying portion 119 which is in an ON state while an audio output of a 2-channel (L/R) is selected, a multi-displaying portion 120 which is in an ON state while an audio output of a 5.1-channel is selected, a memory-displaying portion 121 which is in an ON state while information stored in the memory is reproduced, a random-displaying portion 122 which is in an ON state during the random reproduction, a repeat-displaying portion 123 which is in an ON state during the repeat reproduction, an angle icon-displaying portion 124 which is in an ON state while an image part recorded at multiple angles is reproduced, an information-displaying portion 125 which is constituted by a plurality of segments able to display characters and numeric characters, and which displays information on the total time, the elapsed time and the remaining time, the title number, the chapter number, the message and the like of the disc, and a video output-displaying portion 126 which displays information on a kind of video signal outputted through an output terminal.

The video output-displaying portion 126 is in an ON state while an HDMI terminal or a D terminal through which the digital video signal is outputted is selected, and lights the display which is selected in correspondence to the resolution (480 interlaced (480i), 480 progressive (480p), 720 progressive (720p), 1080 interlaced (1080i)) of the output video signal.

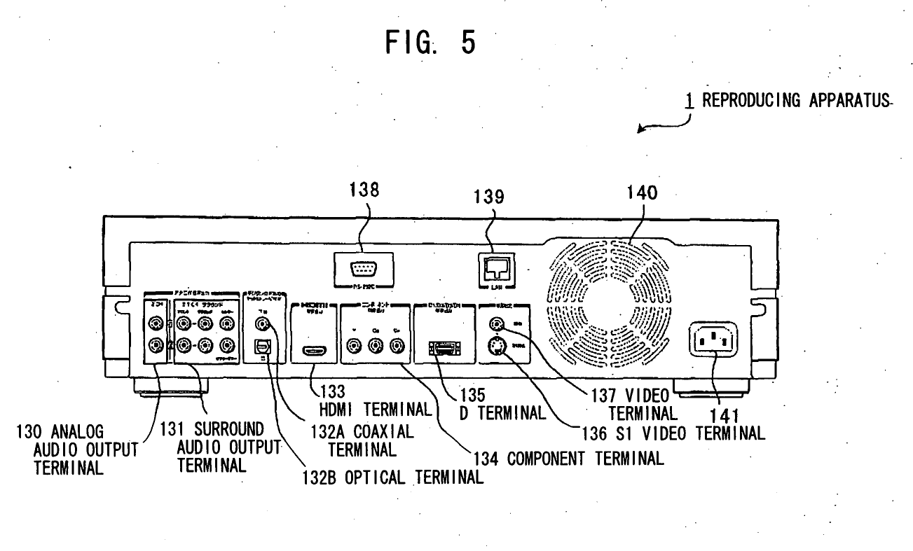

FIG. 5 is a rear view of the main body of the reproducing apparatus 1 according to the first embodiment of the present invention. The reproducing apparatus 1 has an analog audio output terminal 130 through which an audio signal of the 2-channel (L/R) is outputted, a surround audio output terminal 131 through which an audio signal of the 5.1-channel is outputted, a coaxial terminal 132A and an optical terminal 132B as digital audio output terminals, an HDMI terminal 133 through which an HDMI output is performed, a component terminal 134 through which a component video output is performed, a D terminal 135 through which an analog video output is performed in accordance with the D terminal standard (D1 to D4), an S1 video terminal 136 and a video terminal (composite video terminal) 137, an RS-232 terminal 138 as a function expanding terminal, a LAN terminal 139 through which the reproducing apparatus 1 is connected to a broad band normally-connected network, a ventilating hole 140 through which the heat is exhausted to the outside in accordance with the rotation of a ventilating fun provided inside the main body, and a power source input terminal 141. All these terminals are provided on the rear of the main body.

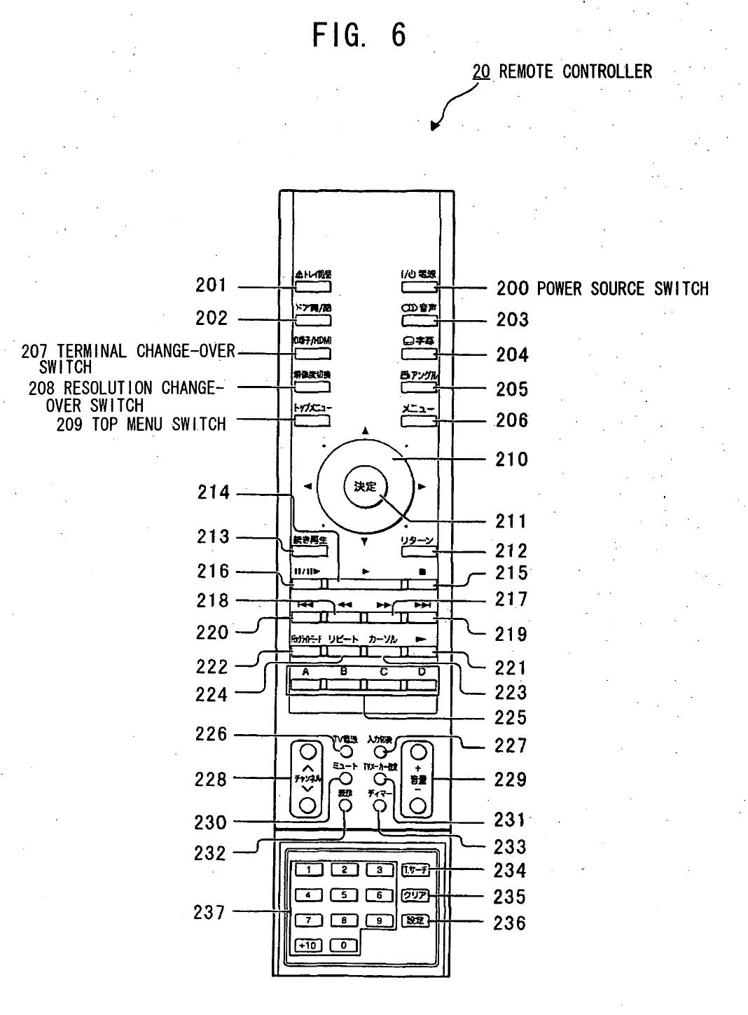

FIG. 6 is a view showing an overall remote controller for remotely controlling the reproducing apparatus 1 according to the first embodiment of the present invention. The remote controller (hereinafter referred to as “the remocon” for short) 20 has a power source switch 200, a tray-opening/closing switch 201, a door-opening/closing switch 202, an audio switch 203, a title switch 204 with which current title setting is displayed, an angle switch 205 with which an angle is switched to one at which a user wants to see an image in portions recorded at a plurality of camera angles, a menu switch 206 with which the recorded contents are displayed in the form of a list, a terminal change-over switch 207 with which a digital video output (HDMI) and other analog video outputs are changed to each other, a resolution change-over switch 208 with which the resolution of a video output corresponding to a scanning system of a television connected thereto is selected, a top menu switch 209 with which a top menu is displayed, a direction switch 210 with which a desired item is selected among items displayed on a screen, a decision switch 211 with which a decision manipulation is performed with respect to the selected item, a return switch 202 with which a current picture is returned back to a preceding picture, a continuance reproduction switch 213 with which the reproduction is performed from a finally stopped position, a reproduction switch 214 with which the reproduction is performed, a stop switch 215 with which the reproduction is stopped, a temporary stop/frame feed switch 216 with which temporary stop/frame feed for the reproduction is performed, and a rapid feed switch 217 with which rapid feed for the reproduction is performed. Also, the remocon 20 has a rapid return switch 218 with which rapid return for the reproduction is performed, skip switches 219 and 220 with which a skip manipulation is performed, a slow switch 221 with which slow reproduction is performed, a back light mode switch 222 with which a back light built in the remocon 20 is turned ON/OFF, a cursor switch 223 with which a cursor function for eight directions made by the direction switch 210 is operated/dis-operated, a repeat switch 224 with which repetitive reproduction is performed, an ABCD switch 225 which is manipulated in accordance with a switch manipulation instruction displayed during the reproduction for the DVD disc, a television power source switch 226, a television input change-over switch 227, a television channel switch 228, a television volume switch 229, a television mute switch 230, a television maker setting switch 231, a display switch 232 with which display corresponding to a reproduction state or a kind of disc is made, a dimmer switch 233 with which brightness of the displaying portion 100 shown in FIG. 4 is switched to another one, a T.search switch 234 with which an elapsed time is specified to set a necessary position of the DVD disc to a predetermined start position, a clear switch 235 with which time display of the inputted item is cleared, a setting switch 236 which is manipulated when initialization is changed, and a number switch 237 with which a numeric value on a time or the like is inputted. At that, the T.search switch 234, the clear switch 235, the setting switch 236, and the number switch 237 are normally covered with a slide type cover (not shown).

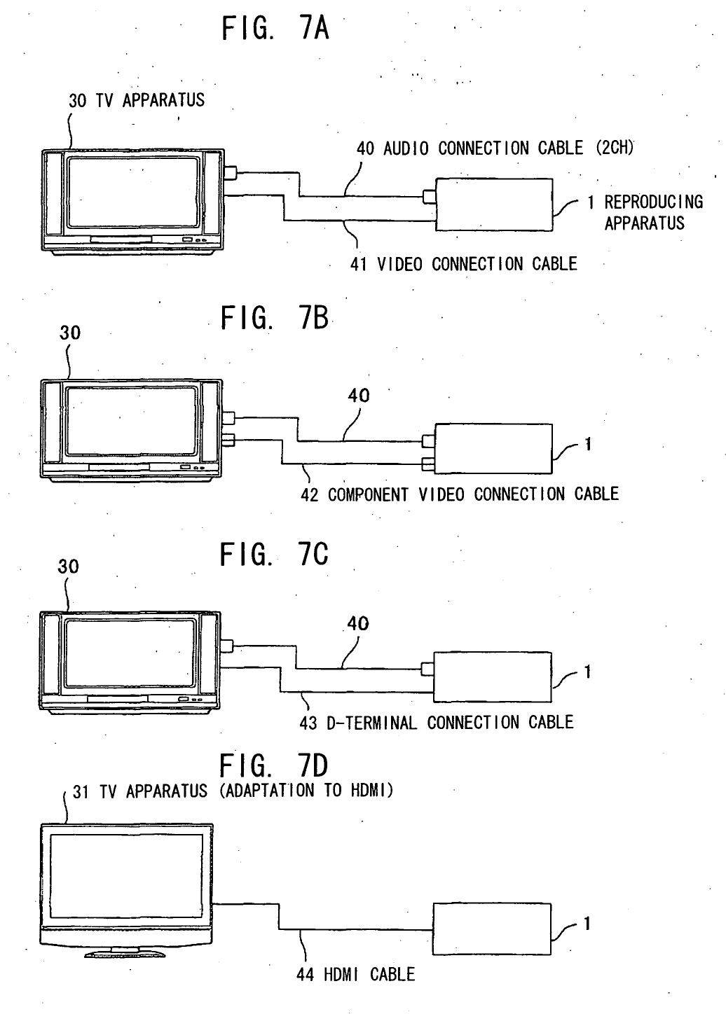

FIGS. 7A and 7B are respectively schematic views showing connection forms between a TV apparatus 30 as an external video-displaying portion and the reproducing apparatus 1. A first connection form is such that as shown in FIG. 7A, the reproducing apparatus 1 is connected to the TV apparatus 30 by using a video connection cable 41 and an audio connection cable 40. In this case, the video terminal 137 of the reproducing apparatus 1 shown in FIG. 5, and a video input terminal of the TV apparatus 30 are. connected to each other through the video connection cable 41. In addition, with respect to the sound, the analog audio output terminal 130 of the reproducing apparatus 1, and an audio input terminal of the TV apparatus 30 are connected to each other through the audio connection cable 40.

At that, in the first connection form, an S video connection cable (not shown) may also be used instead of the video connection cable 41. In this case, the S1 video terminal 136 of the reproducing apparatus 1 shown in FIG. 5, and the S video input terminal of the TV apparatus 30 are connected to each other through the S video connection cable.

A second connection form is such that as shown in FIG. 7B, the reproducing apparatus 1 is connected to the TV apparatus 30 by using a component video connection cable 42 and the audio connection cable 40. In this case, the component terminal 134 of the reproducing apparatus 1 shown in FIG. 5, and a component input terminal of the TV apparatus 30 are connected to each other through the component video connection cable 42. The connection form for the sounds is the same as the first connection form.

A third connection form is such that as shown in FIG. 7C, the reproducing apparatus 1 is connected to the TV apparatus 30 by using a D terminal connection cable 43 and the audio connection cable 40. In this case, the D terminal 135 of the reproducing apparatus 1 shown in FIG. 5, and a D video input terminal of the TV apparatus 30 are connected to each other through the D terminal connection cable 43. The connection form for the sounds is the same as the first connection form.

A fourth connection form is such that as shown in FIG. 7D, the reproducing apparatus 1 is connected to the TV apparatus 30 by using an HDMI cable 44 coping with the digital signal. In this case, the HDMI terminal 133 of the reproducing apparatus 1 shown in FIG. 5, and the HDMI input terminal of the TV apparatus 31 coping with the HDMI are connected to each other through the HDMI cable 44. At that, the audio signal is also transmitted through the HDMI cable 44.

In addition, the audio output can also be turned into a multi-channel sound by connecting the reproducing apparatus 1 to an AV amplifier in accordance with the 5.1-channel analog sound output using the surround audio output terminal 131 in addition to the above-mentioned analog sound output terminal 130, and the digital sound output using the coaxial terminal 132A or the optical terminal 132B.

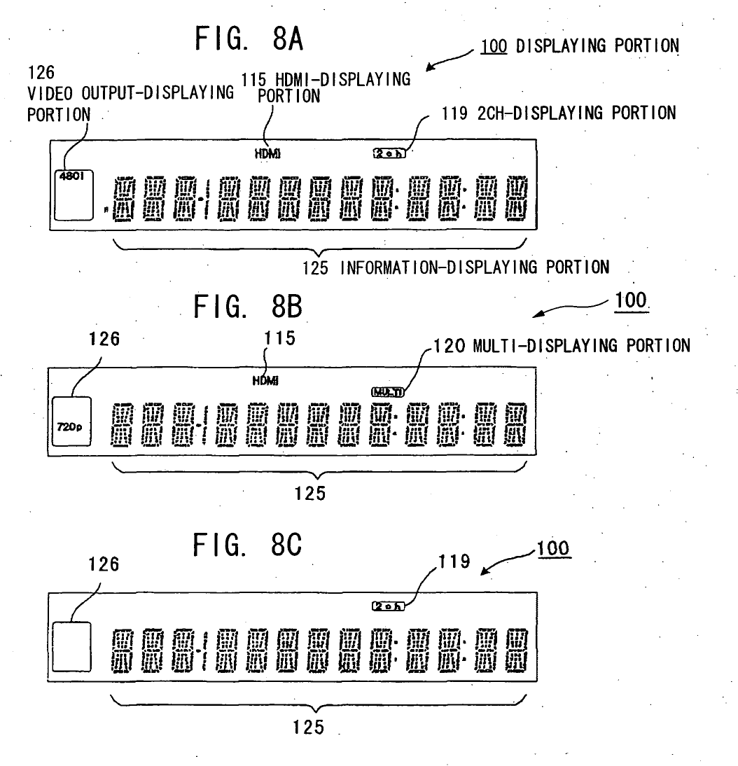

FIGS. 8A to 8C are respectively explanatory views each showing the displaying portion of the reproducing apparatus 1 in a stage in which the reproducing apparatus 1 is unconnected to the TV apparatus.

When a power source code is connected to the power source output terminal 141 provided in the rear of the reproducing apparatus 1 and a state of the reproducing apparatus 1 is changed from a standby state to an operating state in accordance with the manipulation for the remocon 20, “NO DISC” representing that the disc tray 104 is empty is displayed on the information-displaying portion 125 of the displaying portion 100. In addition, the HDMI-displaying portion 115 for showing that the HDMI terminal 133 is selected as the output terminal, and the 2ch-displaying portion 119 for showing that the 2-channel audio output terminal is selected are turned ON as shown in FIG. 8A in the upper portion of the information-displaying portion 125. At that, which of the audio terminals is set during shipment is arbitrarily determined. The video terminal display which is displayed when the power source is initially turned ON is determined in accordance with the setting in the shipment phase.

In addition, when the HDMI terminal 133 is selected, information on the resolution is displayed on the video output-displaying portion 126 for showing the resolution of the video signal. In FIG. 8A, “480i” is displayed as the resolution of the video signal.

In FIG. 8B, the HDMI terminal 133 is selected similarly to the case of FIG. 8A. In this case, “720p” is displayed as the resolution of the video signal to which the preceding resolution is changed by manipulating the resolution change-over switch 208 provided in the remocon 20 shown in FIG. 6. In addition, the multi-displaying portion 120 for showing that the 5.1-channel audio output terminal is selected is in an ON state.

FIG. 8C shows the case where any one of the analog video terminals is selected by manipulating the terminal change-over switch 207 provided in the remocon 20 shown in FIG. 6. In this case, only the 2ch-displaying portion 119 for showing that the channel audio output terminal is selected is in an ON state.

### Manipulation in First Embodiment

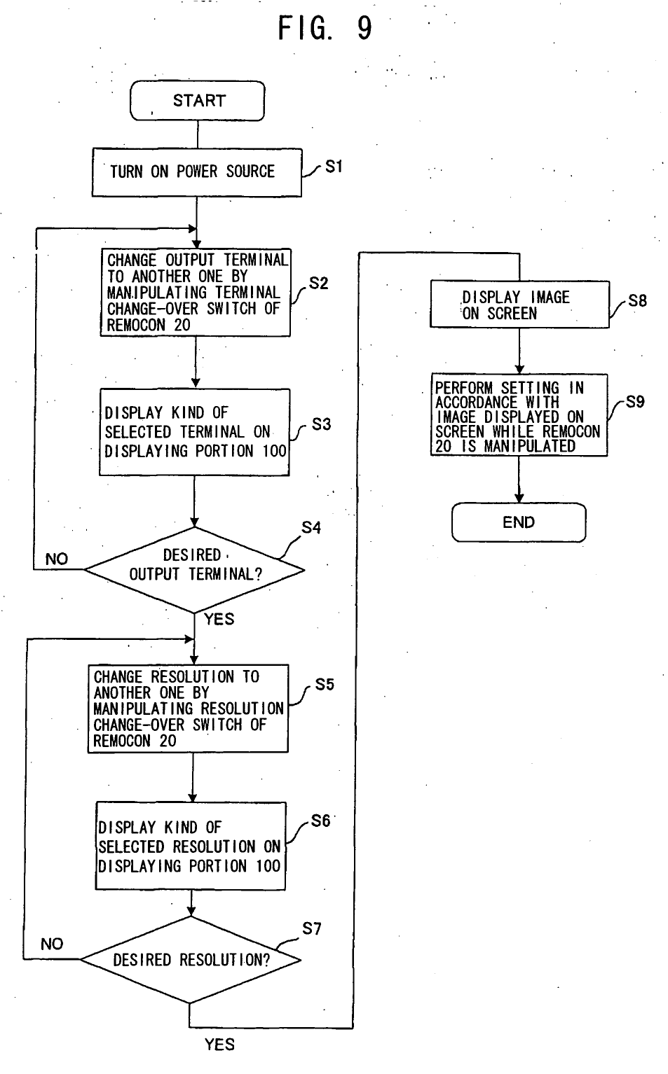

FIG. 9 is a flow chart showing a flow of initialization including the manipulation for the output terminals and the resolution decision in the reproducing apparatus 1 according to the first embodiment of the present invention. A flow of the initialization will hereinafter be described with reference to FIG. 1 to FIGS. 8A to 8C.

Firstly, before handling the reproducing apparatus 1, the user sets a battery in the remocon 20 to provide an available state. Next, when the user connects the power source code to the power source input terminal 141 provided on the rear of the main body of the reproducing apparatus 1, the reproducing apparatus 1 becomes the standby state. The user manipulates the power source switch 200 in this state, whereby the reproducing apparatus 1 becomes the operating state, and “NO DISC” is displayed on the information-displaying portion 125 of the displaying portion 100 (S1).

Next, the user confirms the terminal selection display in the displaying portion 100. Here, when intending to connect the reproducing apparatus 1 to the TV apparatus 31 coping with HDMI through the HDMI cable 44, the user confirms that the HDMI-displaying portion 115 is in the ON state in the displaying portion 100 as shown in FIGS. 8A or 8B. In addition, the user verifies whether or not the resolution is suitably set in accordance with the HDMI output by seeing the video output-displaying portion 126. When the HDMI-displaying portion 115 is in the OFF state, the user changes the video output terminal to suitable one by manipulating the terminal change-over switch 207 of the remocon 20 (S2).

When the user changes the video output terminal to the suitable one by manipulating the remocon 20, the HDMI-displaying portion 115 becomes the ON state or the OFF state in the displaying portion 100 in accordance with the change-over manipulation by the user. When the HDMI-displaying portion 115 is in the ON state, this ON state means that the HDMI terminal 133 is selected as the output terminal, and the HDMI video output is exclusively outputted. On the other hand, when the HDMI-displaying portion 115 is in the OFF state, this OFF state means that the analog video output terminals (the D terminal, the S1 video terminal, the composite video terminal, and the component video terminal) are selected, and thus the analog video output is exclusively outputted (S3). After the desired output terminal is set in such a manner, the resolution is set (S4: YES).

Next, the user adjusts the resolution. That is to say, in the case where the information on the resolution corresponding to the video signal to be outputted to the TV apparatus 31 is not displayed on the video output-displaying portion 126, for example, when desiring not to select the resolution of 720 progressive shown in FIG. 8B, but to select the resolution of 480 interlaced, the user changes the resolution to another one by manipulating the resolution change-over switch 208 of the remocon 20 (S5).

When the user changes the resolution to the another one by manipulating the remocon 20, pieces of information on the resolution are successively displayed on the video output-displaying portion 126 of the displaying portion 100 in accordance with the change-over manipulation by the user. The user selects and sets the suitable one from the pieces of information on the resolution displayed in such a manner (S6). When the user sets the suitable resolution in such a manner, the video signal is outputted to the selected video output terminal (S7: YES). Here, since the selected video output terminal is the HDMI terminal 133, the user connects one end of the HDMI cable 44 to the HDMI terminal 133, and connects the other end thereof to the TV apparatus 31, whereby the digital video signal is outputted to the TV apparatus 31 to be displayed in the form of an digital image on the screen (S8).

Next, the user instructs the TV apparatus 31 to display the setting picture on its screen by manipulating the setting switch 236 of the remocon 20. After performing the necessary setting by manipulating the remocon 20 while seeing the setting picture displayed in such a manner, the user finally manipulates the setting switch 236 again, thereby completing the setting performed in accordance with the displayed picture of the TV apparatus 31 (S9).

According to the first embodiment of the present invention described above, before the reproducing apparatus 1 is connected to the TV apparatus 30 or 31, to which of the video terminals the terminal through which the video signal is to be outputted corresponds is visually displayed on the displaying portion 100 provided in the front panel 10 of the front of the main body. As a result, even in the case of the reproducing apparatus including a plurality of video output terminals, the user can readily and reliably connect the suitable video cable. In addition, not only the information on the kind of video terminal, but also the information on the resolution of the video signal is displayed on the video output-displaying portion 126. Hence, it is possible to dissolve such nonconformity that no picture is displayed in spite of obtaining a connection state.

In addition, the user can perform the manipulation for selection of the video terminal and selection of the resolution while confirming the contents displayed on the displaying portion 100 using the reproducing apparatus 1 by itself without relying on any of the TV pictures. Hence, the user can select the manipulation for connecting the video cable after the video terminal and the resolution are selected in advance, or the manipulation for changing the video terminal and the resolution to another ones, respectively, after connection of the suitable video cable in correspondence to the situation. As a result, the workability for such an installation work that the newly purchased reproducing apparatus 1 is connected to the existing TV apparatus is improved irrespective of the degree of the mastery.

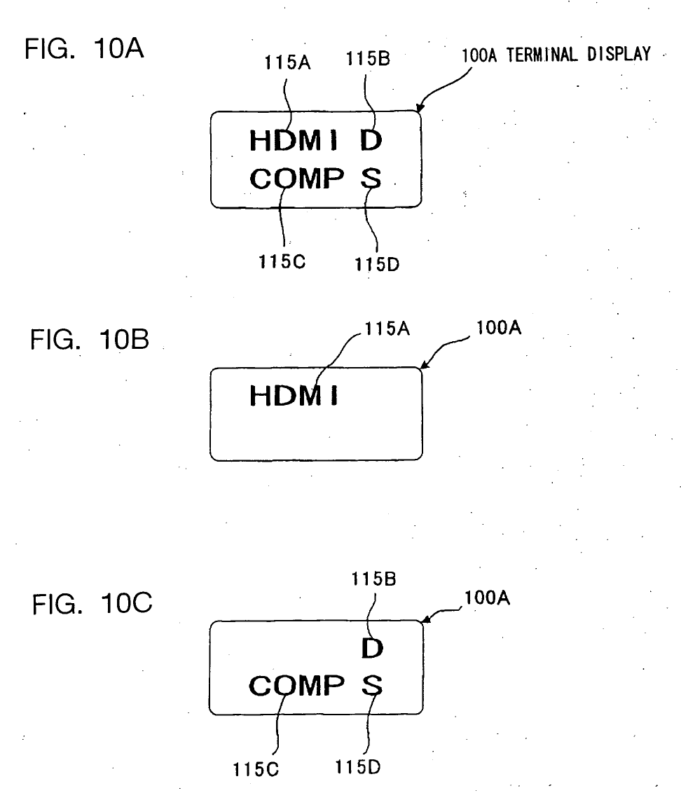

In the first embodiment, the description has been given with respect to the constitution in which the state of the HDMI-displaying portion 115 for showing the selection of the HDMI terminal 133 as the digital video output terminal is made the ON or OFF state in the displaying portion100 of the reproducing apparatus 1, thereby making the judgment on the analog video output or the digital video output. Alternatively, however, for example, terminal display 100A including HDMI display 115A, D display 115B, component display (COMP) 115C, and S1 video display (S) 115D may be provided in the displaying portion 100 as shown in FIG. 10A. In this case, when the HDMI terminal 133 is selected, the HDMI display 115A may be made as shown in FIG. 10B. On the other hand, when other analog video terminals are selected, the D display 115B, the component display 115C, and the S1 video display 115D may be made as shown in FIG. 10C.

Or, when the other analog terminals are selected, the D display 115B, the component display 115C, or the S1 video display 115D may be individually made with respect to the video terminal for which any one of the D display 115B, the component display 115C, and the S1 video display 115D is selected.

### Second Embodiment

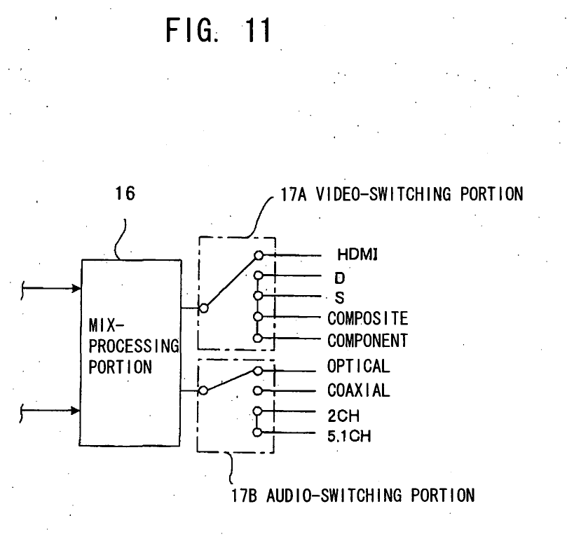

FIG. 11 is a schematic structural diagram showing partially a reproducing apparatus according to a second embodiment of the present invention. The reproducing apparatus 1 includes an audio-switching portion 17B for switching an audio output to another one in addition to the video-switching portion 17 described in the first embodiment. Thus, information on the selected audio output terminal is displayed, together with information on a video switching portion 17A, on the displaying portion 100 provided in the front panel 10 of the reproducing apparatus 1. In the figure, an optical output and a coaxial output can be outputted independent of each other, and an audio output of the 2-channel and an audio output of the 5.1-channel are simultaneously outputted.

According to the second embodiment of the present invention described above, adoption of such a structure results in that such nonconformity that not only the image is not displayed in accordance with the video output, but also the sound is not outputted in accordance with the audio output can be visually dissolved before the reproducing apparatus 1 is connected to an AV amplifier or a speaker.

It should be noted that the present invention is not limited to the first and second embodiments described above, and the various changes can be made without departing from or changing the technical idea of the present invention.

What is claimed is:

1. A reproducing apparatus, comprising:
a remote controller having a terminal-switching portion for selecting a video terminal among a plurality of video terminals including terminals -for a digital video output and an analog video output and serving to transmit a terminal-switching signal generated in accordance with a manipulation for the terminal-switching portion; and
a main body for selecting the video terminal among the plurality of video terminals to be connected to an external image-displaying portion through respective cables by receiving the terminal-switching signal transmitted thereto, and having a displaying portion provided in a front panel, the displaying portion being used to display thereon information on a kind of the video terminal selected and information on resolution of a video signal to be outputted to the external video-displaying portion in a displaying form of characters.

2. A reproducing apparatus according to claim 1, wherein:
the displaying portion displays thereon information on the selected video terminal in a displaying form of characters before connection to the external video-displaying portion.

3. A reproducing apparatus according to claim 1, wherein:
the displaying portion displays thereon information on the resolution of the video signal adapted to be outputted through the selected video terminal in a displaying form of characters before connection to the external video-displaying portion.

4. A reproducing apparatus according to claim 1, wherein:
the remote controller has an independent switch as the terminal-switching portion.

5. A reproducing apparatus according to claim 1, wherein:
the remote controller has an independent resolution change-over switch for changing resolution of the video signal to be outputted through the selected video terminal to another one.

6. A reproducing apparatus, comprising:
a remote controller having a terminal-switching portion for selecting a video terminal among a plurality of video terminals including a terminal for a digital video output or an analog video output obtained from a disc-like storing medium through reproduction and serving to transmit a terminal-switching signal generated in accordance with a manipulation for the terminal-switching portion; and
a main body,
the main body, comprising:
a video-switching portion for selecting the video terminal among the plurality of video terminals to be connected to an external video-displaying portion through respective cables by receiving the terminal-switching signal transmitted thereto;
a decoding portion for forming a video signal corresponding to an output system of the video terminal selected; and
a displaying portion provided in a front panel for displaying thereon information on a kind of the selected video terminal and information on resolution of the video signal to be outputted to the external video-displaying portion in a displaying form of characters.

7. A reproducing apparatus according to claim 6, wherein:
the displaying portion displays thereon information on the selected video terminal in a displaying form of characters before connection to the external video-displaying portion.

8. A reproducing apparatus according to claim 6, wherein:
the displaying portion displays thereon information on the resolution of the video signal adapted to be outputted through the selected video terminal in a displaying form of characters before connection to the external video-displaying portion.

9. A reproducing apparatus according to claim 6, wherein:
the remote controller has an independent switch as the terminal-switching portion.

10. A reproducing apparatus according to claim 6, wherein:
the remote controller has an independent resolution change-over switch for changing resolution of the video signal to be outputted through the selected video terminal to another one.

11. A reproducing apparatus according to claim 6, wherein:
the video switching portion selects the video terminal among the plurality of video terminals so that the video signal corresponding to an output system of the selected video terminal is exclusively outputted against the video signals to be outputted through other video terminals.
